(19) United States
(12) Patent Application Publication
(10) Pub. No.: US 2009/0050675 A1
(43) Pub. Date: Feb. 26, 2009

(54) Friction Welding Method and Components Produced From Steel and Metal Aluminide Using an Intermediary From an Ni Alloy

(75) Inventors: Hartmut Baur, Ertingen (DE); Peter Fledersbacher, Stuttgart (DE); Herbert Gasthuber, Ulm (DE); Michael Scheydecker, Nersingen (DE)

Correspondence Address: Davidson, Davidson & Kappel, LLC, 485 7th Avenue, 14th Floor, New York, NY, 10018, US

(73) Assignee: DaimlerChrysler AG, Stuttgart (DE)

(21) Appl. No.: 11/887,986

(22) PCT Filed: Mar. 27, 2006
(86) PCT No.: PCT/EP2006/002786

§ 371 Date: Oct. 5, 2007

(30) Foreign Application Priority Data
Apr. 7, 2005 (DE) 10 2005 015 947.8

(51) Int. Cl. B23K 20/12; F04D 29/20; F01L 7/06

(52) U.S. Cl. 228/114.5; 416/213 R; 123/190.14

(57) ABSTRACT

A method for connecting a first component from a metal aluminide or a refractory Ti alloy to a second component from steel, metal aluminide or a refractory Ti alloy, especially from a steel shaft, by friction welding is disclosed. An intermediary from an Ni alloy is inserted between the first component and the second component and friction welding is carried out. A connecting layer is produced from the intermediary and is firmly connected on both ends to the first and the second component. A turbocharger rotors and valves for internal combustion engines produced by the disclosed method is also provided.

The present invention relates to a method for joining a first component (1, 3) made of a metal aluminide or a refractory Ti alloy to a second component made of steel or metal aluminide, in particular of a steel shaft (2), by friction welding using an intermediary (4) from a Ni alloy according to the subject matter of claim 1.

The present invention further relates to a turbocharger rotor having a turbine wheel (1), a steel shaft (2) and a compressor wheel (3), the turbine wheel (1) and/or compressor wheel (3) being formed from a metal aluminide and joined to the steel shaft via a connecting layer (4′) from a Ni alloy having a diffusion layer on both sides according to claim 13, as well as a valve for internal combustion engines having a valve disk (5) made of a metal aluminide which is joined to a steel shank (6) via a connecting layer (4′) according to the features of claim 15. Components according to the definition of the species are used in motor vehicle engines and turbochargers for motor vehicle engines.

The need to replace steel valves or turbochargers made of steel by light metal alloys exists for the automotive industry. The conventional one-piece valves or turbocharger rotors of steel are being replaced by multi-piece constructions having as high a proportion as possible of refractory light metal alloys, since it is generally not possible to manufacture complete parts of a suitable quality from metal aluminides. For reasons of strength, it has proved to be practical to keep the axial shank or the axial shaft of steel and manufacture the corresponding valve disk, rotor, or compressor wheel from the light metal or the metal aluminide.

A turbocharger including a rotor and turbine wheel is known from JP-A-2-78734, the turbine wheel made of γ-titanium aluminide (γ-TiAl) being joined to a steel shaft. An intermediary of nickel-based alloy is provided between the turbine wheel and steel shaft, one side of the intermediary being joined to the turbine wheel by friction welding. The friction welded joint formed occasionally does not have satisfactory strength.

A method is known from EP-A-2-1 213 087 in which a valve disk of TiAl is joined to a shank of an α-β-titanium alloy by friction welding. The two parts to be joined are joined to one another by butt welding or widening the joining zone present on the steel shank. The method is suitable due to the close chemical relationship of Ti-alloy and titanium aluminide; however, it is scarcely transferable to the different materials of the steel shank and TiAl valve disk.

A method for joining a steel shaft to a γ-TiAl turbine wheel is known from EP-B-1-0 590 197. The steel shaft and the turbine wheel are joined by friction welding an intermediary of a Ni-based alloy which is firmly joined to the steel shaft. The steel shaft and the connecting piece are preferably joined via an additional previous friction welding operation. This procedure has the disadvantage that two friction welding operations must be carried out. In doing so, precautions must be taken that the first welding layer is not damaged by the second welding operation, in particular that it is not remelted.

It is therefore the object of the present invention to provide a method suitable for joining a first component of refractory light metal alloy to a second refractory component, in particular a steel component, economically and firmly, as well as for the manufacture of a turbocharger rotor having a turbine wheel and/or compressor wheel of light metal alloy and a steel shaft or a valve having a steel shank and a light metal valve disk.

According to the present invention, the object is achieved by a method for joining a first component (1, 3) made of a metal aluminide or a refractory Ti alloy to a second component made of steel or metal aluminide, in particular a steel shaft (2), by friction welding using an intermediary (4) of a Ni alloy according to the subject matter of claim 1 having the features of claim 1, as well as by a turbocharger rotor having the features of claim 13, and by a valve for internal combustion engines having the features of claim 15.

The present invention is described in greater detail with reference to schematic drawings.

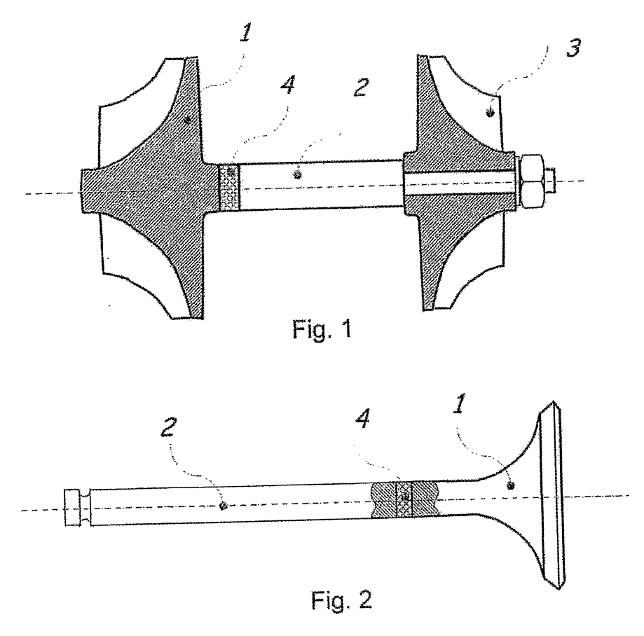

FIG. 1 shows a turbocharger rotor having component (1) of metal aluminide, embodied as a turbine wheel, steel part (2) embodied as a steel shaft, component (3) embodied as a compressor wheel as well as an intermediate layer (4′),

FIG. 2 shows a valve before friction welding to component (1) of metal aluminide embodied as a valve disk, intermediary (4) and steel part (2) embodied as a valve shank,

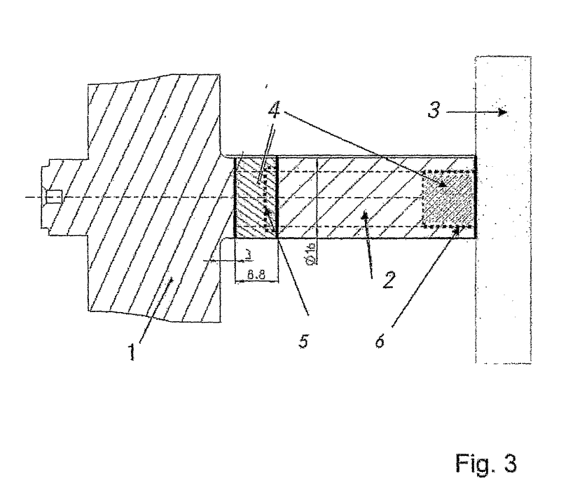

FIG. 3 shows a turbocharger rotor including first component (1) of metal aluminide, embodied as a turbine wheel, and second component (2) embodied as a steel shaft and component (3) embodied as a compressor wheel as well as intermediary (4), second component (2) having a recess (6) for fixing intermediary (4), and intermediary (4) having a recess (5) for placing it on steel part (2) and

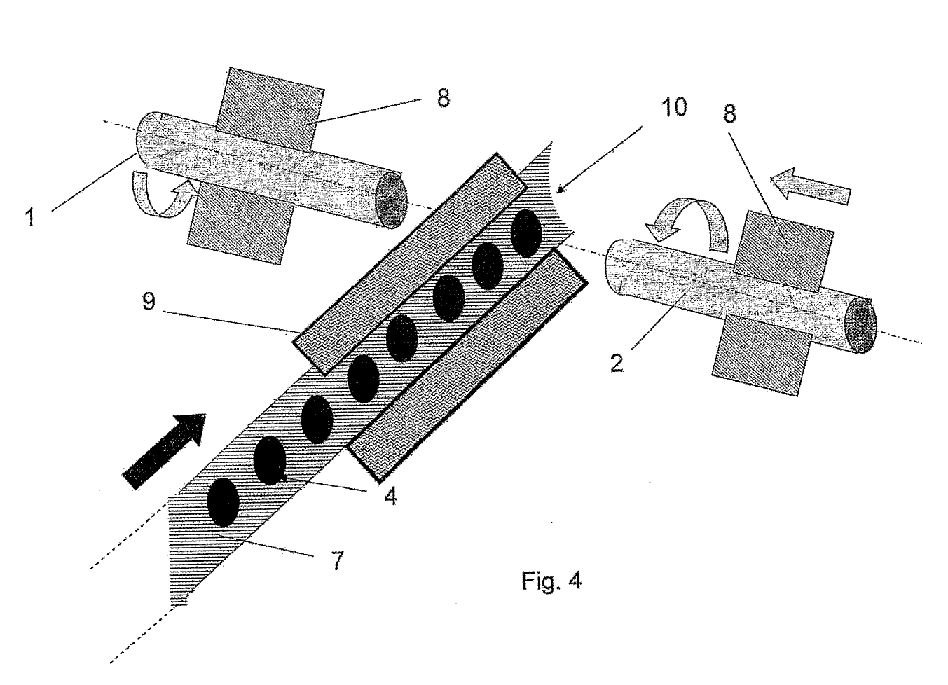

FIG. 4 shows a method for friction welding including components (1, 2), which are movably held via a fixture (8), including a feed mechanism (9) for intermediate pieces (4) fixed in a band (7).

According to the present invention, it is thus provided to introduce an intermediary (4) made of a Ni alloy between the second component, in particular steel part (2) and component (1, 3) in the connection zone, so that a connecting layer (4′) is formed from the intermediary (4). Both sides of the connecting layer are firmly joined to second component (2) and first component (1, 3), ensuring the mechanical coupling of both components. In contrast to the known methods, the joint is produced in a single friction welding operation.

This procedure has the advantage that only one friction welding operation must be carried out. Before the friction welding operation, the connecting piece is not firmly joined to either the steel part or the component, so that the friction welding operation is not able to cause a thermal or mechanical load on a point of connection or joining previously introduced in the vicinity of the joint. In contrast, the combination of two friction welding operations for joining the intermediate piece first to a steel part and then to the titanium aluminide component causes the first friction welding intermediate layer or connecting layer to be impaired.

The method of the present invention thus has the advantage that a comparatively thin intermediate layer may be selected for joining the two workpieces. In principle, the connecting layer must be selected to be just thick enough to form a material and positive joint. However, the connecting layer is preferably designed somewhat thicker so that it acts as a thermal barrier, i.e., a barrier to thermal conduction. This is of significance in particular if the second component is made of steel or a titanium alloy having a lower melting point than the metal aluminide alloy of the first component.

Intermediary (4) preferably has a thickness ranging from 1 mm to 10 mm. During friction welding, the thickness of the intermediary is considerably reduced because the surplus material is pressed laterally out of the connection zone.

Typically, the intermediary (4) is reduced during the friction welding to an intermediate layer (4′) having a thickness ranging from 3 μm to 2000 μm. After the friction welding, the intermediate layer preferably has a thickness greater than 50 μm, preferably ranging from 200 μm to 2000 μm for the joining of steel and metal aluminide. The intermediate layer is characterized by a composition that essentially corresponds to the composition of the intermediary. A diffusion zone is formed on both sides of the intermediate layer. This is a mixing zone in which the material of the intermediate layer and the material of the steel part or of the component interpenetrate more or less strongly. These diffusion zones or mixing zones represent an effective material joint.

As a function of the thickness of the connecting layer and process conditions of the friction welding, the connecting layer may have an interpenetration structure of the three metal alloys involved.

The single-stage friction welding operation must be performed at temperatures corresponding to the friction welding temperatures of the higher-melting metal aluminide. The high temperatures result in a very effective bilateral welding of the intermediary.

The suitable metal aluminides include titanium aluminide, nickel aluminide, or iron aluminide.

A nickel alloy, in particular a nickel-based alloy, is selected as intermediary. Inconel alloys must also be included here. Among other things, preferred Ni alloys contain 2% to 10% Mo and/or 2% to 10% Nb.

In another advantageous embodiment of the intermediary, the Ni alloy is formed by a Ni-based alloy and intercalated ceramic particles. Preferred ceramic particles are SiC, TiC, and/or WC. The ceramic particles act as friction particles that have a favorable impact on the friction welding operation. In the connecting layer, the ceramic particles in particular advantageously reduce the thermal conduction, i.e., the heat transfer.

Also in the event that both components to be joined are of the same metal aluminide, the friction welding joint using a heterogeneous intermediary offers advantages compared to friction welding without an intermediary, since the joint formed according to the present invention has a lower susceptibility to brittle fracture.

The intermediary may be designed as a lamina, film, or cap which is introduced between the connection zones before the friction welding or is loosely affixed to one of the two bodies. It is also possible to join the thus designed intermediary to one of the two bodies mechanically or positively, for example, by pressing on or shrink-fitting. In so doing, it is expedient to be guided by the more suitable geometry of the two components to be joined.

In a preferred embodiment, a recess is provided in the connection zone on one of the two bodies, into which the intermediary in particular as.

Another preferred embodiment of the method is depicted schematically in FIG. 4 and provides that the intermediary affixed in a feed mechanism (9), in particular in a band (7), is continuously fed into the connection zone of the two components. The intermediaries (4) are, for example, embedded, in particular pressed, in a steel band (7) and are fed to the connection zone of the two components (1, 2) with the aid of a plate guide (9). Rods of titanium aluminide may, for example, be provided as components (1, 2) on both sides. Components (1, 2) are held by movable fixtures and are advanced to intermediary (4) for friction welding. After the friction welding, steel band (7) is cut off in front of the welded component, making it possible to remove the component from the friction welding machine. For the next friction welding operation, the steel band is advanced to the connection zone using feed mechanism (9) and brought into position with newly clamped components (1, 3).

The friction welding method may be designed to be substantially more efficient using the continuously feedable and fixed intermediaries. The setup times for the friction welding machine are shortened significantly.

In another embodiment of this version, varying rotational speeds and pressures may be provided by the two components (1) or (2) during the friction welding in order to generate varying welding temperatures or welding pressures on both sides of the intermediary. To this end, it is expedient to provide a very stable construction for the feed mechanism including the band (7) and the intercalated intermediaries (4) in order to be able to set varying pressures on both sides of the band.

In another embodiment of the present invention, the intermediary is not introduced loosely into the connection zone but is instead initially joined to one of the components by a positive connection. If a steel part is provided, it is generally the preferred component for securing the intermediary. The joint itself requires no special strength, since it must merely ensure the fixation of the intermediary for the friction welding operation. For that reason, quite different methods may be used for securing the intermediary. In particular it is not necessary to affix the intermediary by welding or friction welding.

It is preferred in particular that the intermediary is a Ni alloy coating. For example, Ni, nickel alloy, or even a Ni alloy including SiC particles may be electrodeposited. Preferably, the steel part is coated, in particular electroplated. In another embodiment, the coating is made up of a pressed-on powder layer, in particular of a Ni alloy including ceramic particles and/or additional metal particles, in particular Cr, Nb, or Mo.

Typically at least one of the two components, steel part or metal aluminide component, is designed to be rotationally symmetric.

Preferably, the first component is a steel rod or a steel cylinder which is joined to the second component. As a result, the friction welding preferably forms a rotationally symmetric body having its longitudinal axis in the steel part. It is apparent that the friction welding of the present invention may also be applied a plurality of times for affixing a plurality of components to the first component. For example, both ends of a rod-shaped steel part may be successively joined to a titanium aluminide component (1, 3). In a preferred embodiment, both ends of the steel part are simultaneously joined to a component (1, 3). This reduces the number of individual operations. Furthermore, it is possible to produce a very good axial alignment and centering which extends over the entire joined component.

Since the components are firmly secured during friction welding, it is not possible for any distortion or offsetting or bending to occur within the connecting layer. This is a significant advantage for all components manufactured according to the present invention, in particular if they are to be used as rapidly rotating parts.

If a cylinder or hollow part is used as a steel part, it is expedient to close the ends to be welded. If intermediaries that are thick in particular are used, it is also possible not to close the ends until the friction welding.

Another aspect of the present invention relates to a turbocharger rotor having a turbine wheel (1), a steel shaft (2) and a compressor wheel (3), the turbine wheel (1) and/or compressor wheel (3) being formed from a metal aluminide and joined to a steel shaft via a connecting layer (4′) using a friction welding operation, the connecting layer (4′) being formed by a Ni alloy having a diffusion layer on both sides and having a thickness ranging from 3 μm to 2 mm.

It is of essential importance for the connecting layer to be designed as thin as possible. On the one hand, the layer should not cause any mechanical weakness in relation to the steel or metal aluminide materials; however, on the other hand, it should also form a thermal barrier which is as effective as possible in reducing the heat transfer to the steel. In the operation, the metal aluminide parts are substantially hotter than the steel shaft so that the heat transfer must accordingly be reduced as much as possible. A thickness of the connecting layer or welding seam ranging from 100 μm to 1000 μm is preferred in particular.

In another preferred embodiment of the present invention, the welding seam or connecting layer (4′) is partially penetrated by steel and/or metal aluminide; the connecting layer thus has a penetration structure of the three metal alloys involved.

The friction welding method of the present invention represents a cost-effective process for reliably manufacturing these turbocharger rotors having a thin welding seam or connecting layer.

In a preferred embodiment, steel shaft (2) is joined on the one hand to turbine wheel (1) and on the other hand to compressor wheel (3) via the particular connecting layer (4′). Preferably, the steel shaft is joined to the corresponding components via the friction welding process of the present invention.

Another aspect of the present invention relates to a valve for internal combustion engines having a valve disk (5) of a metal aluminide which is joined to a steel shank (6) via a connecting layer (4′). It is preferred in particular that this valve is produced using the friction welding process of the present invention, connecting layer (4′) being formed by a Ni alloy having a diffusion layer on both sides. The thickness of the connecting layer ranges from 3 μm to 2 mm.

1-17. (canceled)

18: A method for joining a first component made of a metal aluminide or a refractory Ti alloy to a second component made of steel, metal aluminide, or refractory Ti alloy, by friction welding, comprising:
introducing an intermediary made of a Ni alloy between the first component and the second component in a connection zone;
subsequently carrying out a single friction welding operation, the first component being firmly joined to the second component by forming a connecting layer from the intermediary between the first component and second component.

19: The method as recited in claim 18 wherein the intermediary is selected to have a thickness ranging from 1 mm to 10 mm.

20: The method as recited in claim 18 wherein the intermediary is reduced during the friction welding to a thickness ranging from 3 μm to 2000 μm.

21: The method as recited in claim 18 wherein a diffusion layer is formed on both sides of the intermediate layer during the friction welding.

22: The method as recited in claim 18 wherein titanium aluminide is selected as the metal aluminide.

23: The method as recited in claim 18 wherein the intermediary is positively joined to one of the first and second components before being introduced into the connection zone.

24: The method as recited in claim 18 wherein the intermediary is selected from a lamina, film, cap, or coating.

25: The method as recited in claim 24 wherein the intermediary is secured via a feed mechanism and continuously fed into the connection zone of the first and second components.

26: The method as recited in claim 25 wherein varying rotational speeds and pressures are provided for first and second components during the friction welding in order to generate varying welding temperatures or welding pressures on both sides of the intermediary.

27: The method as recited in claim 18 wherein both ends of the second component are joined to the first component in succession.

28: The method as recited in claim 18 wherein both ends of the second component are joined to the first component simultaneously.

29: The method as recited in claim 18 wherein the first component is formed by a valve disk, a compressor wheel, or a turbine wheel and the second component is formed by a steel shank or a steel shaft.

30: The method as recited in claim 18 wherein the second component is a hollow steel part.

31: The method as recited in claim 30 wherein the hollow steel part is closed on at least the side of the joint.

32: The method as recited in claim 18 wherein the second component is a steel shaft.

33: A turbocharger rotor comprising:
a turbine wheel;
a steel shaft; and
a compressor wheel, the turbine wheel and/or compressor wheel being formed from a metal aluminide and joined to the steel shaft via a connecting layer, obtainable according to the method as recited in claim 18, the connecting layer being formed by a Ni alloy having a diffusion layer on both sides and having a thickness ranging from 3 μm to 2 mm.

34: The turbocharger rotor as recited in claim 33 wherein the steel shaft is joined on the one hand to the turbine wheel and on the other hand to the compressor wheel via the connecting layer.

35: A valve for internal combustion engines comprising:
a valve disk made of a metal aluminide and joined to a steel shaft via a connecting layer and obtainable according to the method of claim 18, the connecting layer being formed by a Ni alloy having a diffusion layer on both sides and having a thickness ranging from 3 μm to 2 mm.
